(19) United States
(12) Patent Application Publication
(10) Pub. No.: US 2013/0243247 A1
(43) Pub. Date: Sep. 19, 2013

(54) PERIPHERAL INFORMATION GENERATING APPARATUS, CONVEYANCE, PERIPHERAL INFORMATION GENERATING METHOD, AND COMPUTER-READABLE STORAGE MEDIUM

(71) Applicant: SHARP KABUSHIKI KAISHA, Osaka-shi (JP)

(72) Inventors: Tomohiro SAKAUE, Osaka-shi (JP); Yoshiyuki TAKAHIRA, Osaka-shi (JP); Koji TAKAHASHI, Osaka-shi (JP); Hiroyuki NISHIMOTO, Osaka-shi (JP); Shuhichi HIRUKAWA, Osaka-shi (JP)

(73) Assignee: SHARP KABUSHIKI KAISHA, Osaka-shi (JP)

(21) Appl. No.: 13/784,484

(22) Filed: Mar. 4, 2013

(30) Foreign Application Priority Data
Mar. 19, 2012 (JP) 2012-062564

(51) Int. Cl. G06K 9/32

(52) U.S. Cl. CPC G06K 9/3241
USPC 382/103

(57) ABSTRACT

The peripheral information generating apparatus includes (i) a projection section for forming a projection pattern L, which at least partially has a continuous profile, on a road by irradiating the road with light, (ii) an image capturing section, and (iii) an image analyzing section for generating peripheral information, which indicates a peripheral situation of the peripheral information generating apparatus and of the road, by analyzing the projection pattern.

This Nonprovisional application claims priority under 35 U.S.C. §119 on Patent Application No. 2012-062564 filed in Japan on Mar. 19, 2012, the entire contents of which are hereby incorporated by reference.

### TECHNICAL FIELD

The present invention relates to (i) a peripheral information generating apparatus capable of, by analyzing a projection pattern, generating peripheral information that indicates a peripheral situation of the apparatus and of a projection target, (ii) a conveyance, (iii) a peripheral information generating method, and (iv) a computer-readable storage medium.

### BACKGROUND ART

Conventionally, there have been known vehicle driving support apparatuses that (i) irradiates the periphery of a vehicle with light, (ii) generates peripheral information of the vehicle by detecting reflected light, and (iii) carries out (a) intervention control such as automatic braking or automatic steering for accident avoidance or (b) alarm control for giving an alarm, in a case where a risk factor is detected.

A vehicle driving support apparatus disclosed in Patent Literature 1 (i) irradiates a road surface with a laser beam having a geometric shape and (ii) determines, based on a location of reflected light, whether or not an obstacle exists. The vehicle driving support apparatus of Patent Literature 1 (i) detects noise by comparing the geometric shape with a shape of the reflected laser beam and (ii) removes the noise from the reflected laser beam which has been actually detected.

A vehicular periphery monitoring apparatus disclosed in Patent Literature 2 detects existence of an obstacle by (i) emitting a laser beam in a horizontal direction and (ii) imaging scattered light that has been obtained when the laser beam hit the obstacle.

A road gradient estimating apparatus disclosed in Patent Literature 3 (i) radially irradiates a road surface with a laser beam and (ii) calculates a reflection point based on the reflected laser beam. In a case where a gradient of a line segment, which connects a first reflection point with a second reflection point that has been detected immediately before the first reflection point is detected, is not more than a predetermined angle, the road gradient estimating apparatus then determines the gradient as a gradient of the road surface.

Patent Literature 4 discloses an obstacle detecting apparatus provided in a vehicle (hereinafter, referred to as “first vehicle”). The obstacle detecting apparatus scans laser beams, which have been emitted from a laser diode at constant intervals, in a Lissajous waveform pattern in a predetermined range of 20° of the first vehicle. Further, in a case where a second vehicle is running ahead of the first vehicle in a lane where the first vehicle is running, the obstacle detecting apparatus causes the laser diode to emit laser beams at shorter intervals while the scanning is carried out in a narrow region (i) at both ends and (ii) which extends in a front direction of the first vehicle. This increases density of laser beams with which the region is irradiated, and this allows the obstacle detecting apparatus to quickly detect a third vehicle that has cut in between the second vehicle and the first vehicle.

Patent Literature 5 discloses a periphery monitoring apparatus for use in service vehicle, which apparatus (i) irradiates, in a scanning manner, a monitored region with laser beams emitted from the service vehicle, (ii) receives laser beams reflected from a worker, and (iii) detects presence of the worker based on levels of received laser beams. The laser beams which have been emitted toward the monitored region have a spiral pattern.

### CITATION LIST

### Patent Literatures

### Patent Literature 1

Japanese Patent Application Publication, Tokukai No. 2007-83832 A (Publication Date: Apr. 5, 2007)

### Patent Literature 2

Japanese Patent Application Publication, Tokukai No. 2007-276613 A (Publication Date: Oct. 25, 2007)

### Patent Literature 3

Japanese Patent Application Publication, Tokukai No. 2011-106877 A (Publication Date: Jun. 2, 2011)

### Patent Literature 4

Japanese Patent Application Publication, Tokukai No. 2003-28960 A (Publication Date: Jan. 29, 2003)

### Patent Literature 5

Japanese Patent Application Publication, Tokukai No. 2005-180943 A (Publication Date: Jul. 7, 2005)

### SUMMARY OF INVENTION

### Technical Problem

However, techniques disclosed in Patent Literatures 1 through 3 have the following problems.

The vehicle driving support apparatus of Patent Literature 1 emits a laser beam with a laser pattern having a spot shape. Therefore, the vehicle driving support apparatus can neither detect an obstacle which is present between spots nor continuously detect a state of a moving obstacle.

The vehicular periphery monitoring apparatus of Patent Literature 2 has a laser emitting section for emitting laser beams that spread in a horizontal direction. With the configuration, the vehicular periphery monitoring apparatus (i) detects all objects in a direction in which the laser beams are emitted and (ii) needs to have a plurality of light sources in a case where an obstacle is significantly high in a vertical direction.

The road gradient estimating apparatus of Patent Literature 3 needs to measure a starting point and an ending point of an inclination so as to detect the first reflection point and the second reflection point. Moreover, the road gradient estimating apparatus may fail to accurately measure a gradient due to slight unevenness of a road surface. Further, since the road gradient estimating apparatus radially irradiates a road surface with laser beams, the road gradient estimating apparatus needs to (i) measure reflected laser beams from many points and (ii) carry out an enormous amount of processes.

Neither the obstacle detecting apparatus of the Patent Literature 4 nor the periphery monitoring apparatus for use in service vehicle of Patent Literature 5 is configured to generate peripheral information by (i) capturing image of a projection pattern formed by irradiating a projection target with light and (ii) analyzing the image of the projection pattern. Further, the method for forming a projection pattern by each of the obstacle detecting apparatus of the Patent Literature 4 and the periphery monitoring apparatus of Patent Literature 5 is limited to the scanning of light.

The present invention is accomplished to solve the problems, and an object of the present invention is to provide (i) a peripheral information generating apparatus that generates, by analyzing a projection pattern, peripheral information which indicates a peripheral situation of the apparatus and of a projection target, (ii) a conveyance, (iii) a peripheral information generating method, and (iv) a computer-readable storage medium.

### Solution to Problem

In order to attain the object, a peripheral information generating apparatus in accordance with an aspect of the present invention includes a projection section for forming a projection pattern, which at least partially has a continuous profile, on a surface of a projection target by irradiating the projection target with light; an image capturing section for capturing an image of the projection pattern formed on the surface; and an image analyzing section for generating peripheral information, which indicates a peripheral situation of the peripheral information generating apparatus and of the projection target, by analyzing the projection pattern in the image captured by the image capturing section.

In order to attain the object, a method for generating peripheral information in accordance with an aspect of the present invention includes the steps of: (a) forming a projection pattern, which at least partially has a continuous profile, on a surface of a projection target by irradiating the projection target with light; (b) capturing an image of the projection pattern formed on the surface in the step (a); and (c) generating peripheral information, which indicates a peripheral situation of the projection target, by analyzing the projection pattern in the image captured in the step (b).

### Advantageous Effects of Invention

As above described, the peripheral information generating apparatus of the present invention includes a projection section for forming a projection pattern, which at least partially has a continuous profile, on a surface of a projection target by irradiating the projection target with light; an image capturing section for capturing an image of the projection pattern formed on the surface; and an image analyzing section for generating peripheral information, which indicates a peripheral situation of the peripheral information generating apparatus and of the projection target, by analyzing the projection pattern in the image captured by the image capturing section.

As above described, the method of the present invention for generating peripheral information includes the steps of: (a) forming a projection pattern, which at least partially has a continuous profile, on a surface of a projection target by irradiating the projection target with light; (b) capturing an image of the projection pattern formed on the surface in the step (a); and (c) generating peripheral information, which indicates a peripheral situation of the projection target, by analyzing the projection pattern in the image captured in the step (b).

This makes it possible to generate peripheral information, which indicates a peripheral situation of the peripheral information generating apparatus and of the projection target, by analyzing the projection pattern.

### BRIEF DESCRIPTION OF DRAWINGS

FIG. 1 is an explanatory view for describing an operation of a peripheral information generating apparatus mounted in a vehicle.

FIG. 2 is a block diagram illustrating (i) a peripheral information generating apparatus in accordance with an embodiment of the present invention and (ii) a vehicle in which the peripheral information generating apparatus is mounted.

FIG. 3 is a view schematically illustrating a projection section.

FIG. 4 is an explanatory view for describing projection patterns and contours of the respective projection patterns. FIG. 4(a) is an explanatory view for describing an example of a projection pattern and a contour of the projection pattern. FIG. 4(b) is an explanatory view for describing another example of the projection pattern and the contour of the projection pattern. In FIG. 4, parts shaded by oblique lines represent the projection patterns, and the contours of the respective projection patterns are indicated by thick lines.

FIG. 5 is an explanatory view for describing projection patterns and contours of the respective projection patterns. FIG. 5(a) illustrates a quadrangular projection pattern and a contour of the quadrangular projection pattern. FIG. 5(b) illustrates (i) a projection pattern having a shape defined by two straight lines and two curved lines and (ii) a contour of the projection pattern. FIG. 5(c) illustrates a rhombic projection pattern and a contour of the rhombic projection pattern. FIG. 5(d) illustrates a projection pattern having a shape of the alphabet “C” and a contour of the projection pattern. FIG. 5(e) illustrates a rod-like projection pattern and a contour of the rod-like projection pattern. FIG. 5(f) illustrates a lattice-shaped projection pattern and a contour of the lattice-shaped projection pattern. In FIG. 5, parts shaded by oblique lines represent the projection patterns, and the contours of the respective projection patterns are indicated by thick lines.

FIG. 6 is a flowchart for describing how to generate peripheral information.

FIG. 7 is an explanatory view for describing another operation of a peripheral information generating apparatus mounted in a vehicle.

FIG. 8 is an explanatory view for describing yet another operation of a peripheral information generating apparatus mounted in a vehicle.

FIG. 9 is an explanatory view for describing yet another operation of a peripheral information generating apparatus mounted in a vehicle.

FIG. 10 is an explanatory view for describing yet another operation of a peripheral information generating apparatus mounted in a vehicle.

### DESCRIPTION OF EMBODIMENTS

The following description will discuss a peripheral information generating apparatus 1 and the like in accordance with an embodiment of the present invention, with reference to drawings. Note that identical reference numerals are given to members and components that have identical functions and names, and such members and components will not be repeatedly described.

[Schematic Description of Peripheral Information Generating Apparatus 1]

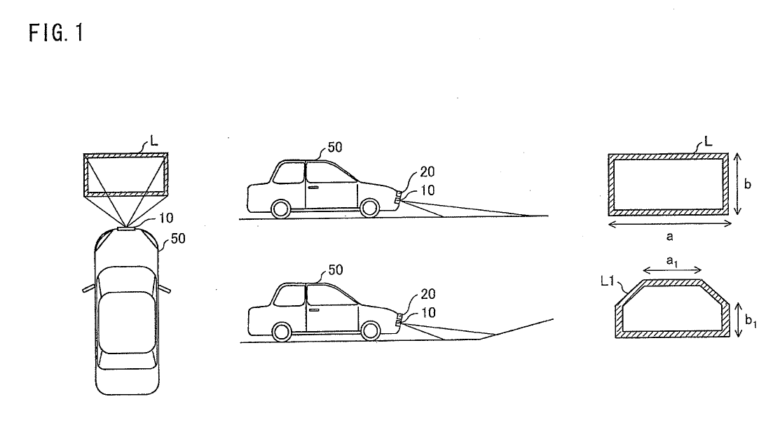

First, a configuration of the peripheral information generating apparatus 1 and how the peripheral information generating apparatus 1 operates are schematically described with reference to FIG. 1. FIG. 1 is an explanatory view for describing an operation of the peripheral information generating apparatus 1 which is mounted in a vehicle 50.

The peripheral information generating apparatus 1 is provided in the vehicle 50. The peripheral information generating apparatus 1 includes a projection section 10. The projection section 10 forms a projection pattern L on a road by irradiating the road with light. The projection section 10 may be provided anywhere in the vehicle 50, provided that the projection section 10 can irradiate a road with light. The vehicle 50 may include a single projection section 10 or a plurality of projection sections 10.

The projection pattern L has a quadrangular shape. Accordingly, the projection pattern L is being in the quadrangular shape while the vehicle 50 is running on a flat road. Meanwhile, when the vehicle 50 comes to a slope (in FIG. 1, an upward slope), the projection pattern L changes to a projection pattern L1 having a hexagonal shape. As shown in FIG. 1, the projection pattern L is the quadrangular shape obtained by a×b. Meanwhile, the projection pattern L1 has the hexagonal shape made up of (i) a trapezoid having two bases a and a₁ and a height (b−b₁) and (ii) a quadrangle obtained by a×b₁.

The peripheral information generating apparatus 1 includes an image capturing section 20 that captures an image of the projection pattern L1. The image capturing section 20 may be provided anywhere in the vehicle 50, provided that the image capturing section 20 can capture an image of a projection pattern formed on a road. The vehicle 50 may include a single image capturing section 20 or a plurality of image capturing sections 20.

The peripheral information generating apparatus 1 further includes an image analyzing section 30 (not illustrated) that analyzes the projection pattern so as to determine (i) that the vehicle 50 is coming near the upward slope and (ii) how much degree (angle) the upward slope is inclined, on the basis of (i) a change from the projection pattern L to the projection pattern L1 and (ii) an amount of the change. The image analyzing section 30 then generates peripheral information indicative of a peripheral situation of the peripheral information generating apparatus 1 on the basis of the analysis results.

As such, by analyzing the projection patterns, the peripheral information generating apparatus 1 generates the peripheral information indicative of the peripheral situation (such as presence of a slope, an angle of a slope, presence of an obstacle, a location of an obstacle, unevenness of a road, presence of an oncoming vehicle and/or a vehicle running parallel to the vehicle 50, a distance between the vehicle 50 and an oncoming vehicle or a vehicle running parallel to the vehicle 50, a width of a road, and a height of an elevated road) of the peripheral information generating apparatus 1 and of a projection target. Moreover, the peripheral information generating apparatus 1 informs a user of generated peripheral information in cooperation with an output section (such as a car navigation system and a speaker) mounted in the vehicle 50.

The following description will discuss further detailed configurations of components, etc. of the peripheral information generating apparatus 1.

[Configurations of main components of peripheral information generating apparatus 1]

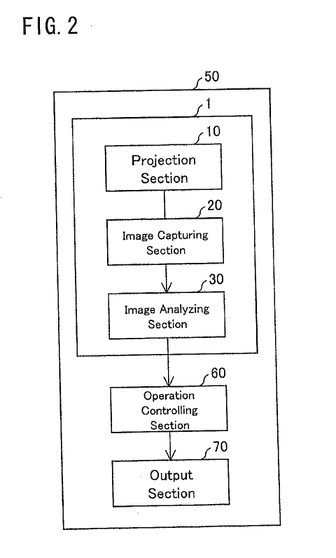

FIG. 2 is a block diagram illustrating (i) the peripheral information generating apparatus 1 and (ii) the vehicle 50 in which the peripheral information generating apparatus 1 is mounted.

The peripheral information generating apparatus 1 includes the projection section 10, the image capturing section 20, and the image analyzing section 30. The projection section 10 irradiates a projection target (such as a road or an obstacle) with light so as to form a projection pattern, which at least partially has a continuous profile, on a surface of the projection target. The image capturing section 20 captures an image of the projection pattern. The image analyzing section 30 analyzes the projection pattern in the image, which has been captured by the image capturing section 20, so as to generate peripheral information that indicates a peripheral situation of the peripheral information generating apparatus 1 and of the projection target. The image analyzing section 30 supplies, to an operation controlling section 60 of the vehicle 50, the peripheral information thus generated.

The following description will discuss in further detail the projection section 10, the image capturing section 20, and the image analyzing section 30. Note that the operation controlling section 60 and an output section 70 which are to be mounted in the vehicle 50 will be described further later.

(Projection Section)

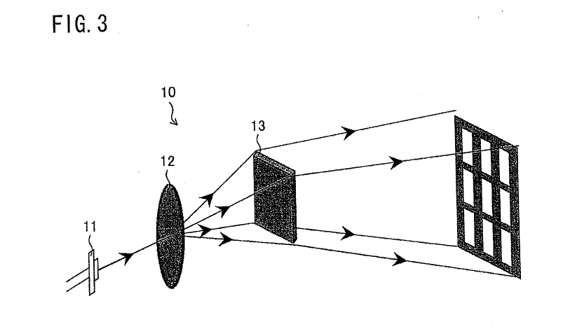

The projection section 10 is detailed with reference to FIG. 3. FIG. 3 is a view schematically illustrating the projection section 10. Note that FIG. 3 illustrates mere an example of the projection section 10, and therefore the projection section 10 can be configured otherwise.

The projection section 10 includes a light source 11, a lens 12, and a hologram 13.

The light source 11 is, for example, a laser element for emitting a laser beam. Note that such a laser element may be either (i) a laser element in which one (1) chip has one (1) light emitting point or (ii) a laser element in which one (1) chip has a plurality of light emitting points.

The laser beam has a high directivity and is suitable for being propagated through long distance. The projection section 10 can irradiate a projection target, which is distant from the projection section 10, with a laser beam by utilizing the advantageous features of the laser beam, i.e., by forming a projection pattern on a surface of the projection target by the use of the laser beam. Note that the light source 11 may be another type of light source such as an LED.

Note here that the light source 11 may be a light source that emits light having a long or short wavelength which the sunlight does not have (i.e., a wavelength different from that of sunlight). Specifically, for example, a light source that emits light having a wavelength of not less than 3000 nm can be employed as the light source 11.

In this case, the image capturing section 20 can capture an image of a projection pattern without being affected by a noise caused by reflection of sunlight. In a case where a member (such as a film) for blocking a wavelength of the sunlight is employed, the image capturing section 20 can recognize a projection pattern even with the use of a low-power laser beam. Further, by using such a member for blocking a wavelength of the sunlight, the image capturing section 20 can eliminate the noise caused by the reflection of sunlight, when the image capturing section captures an image.

Alternatively, the light source 11 may emit light having a wavelength which falls within an infrared region or within an ultraviolet region (i.e., a wavelength of not more than 400 nm or not less than 700 nm). In this case, the projection pattern is invisible to naked eyes. Therefore, scenery is not spoiled even in a case where the projection pattern is formed.

Alternatively, the light source 11 may emit light having a wavelength which falls within a visible region (i.e., 400 nm to 700 nm). In this case, a projection pattern is visible to naked eyes, and therefore, in a case where the peripheral information generating apparatus 1 is mounted in the vehicle 50, it is possible to make others such as other vehicles and passers-by aware of the presence of the vehicle 50 through the visualization of the projection pattern. This makes it possible to improve traffic safety.

As described above, the type and the wavelength of the light source 11 are not limited to specific ones.

The lens 12 guides, to the hologram 13, light emitted by the light source 11. Specifically, the lens 12 causes light, which has been emitted by the light source 11 and has entered the lens 12, to be converged or scattered to the entire hologram 13. The lens 12 may be modified as appropriate in terms of a type, the number, and the like, provided that the lens 12 has such a function. Further, where to provide the lens 12, how to fix the lens 12, and the like, may be appropriately determined in accordance with a relation between the lens 12, the light source 11, the hologram 13, and the like.

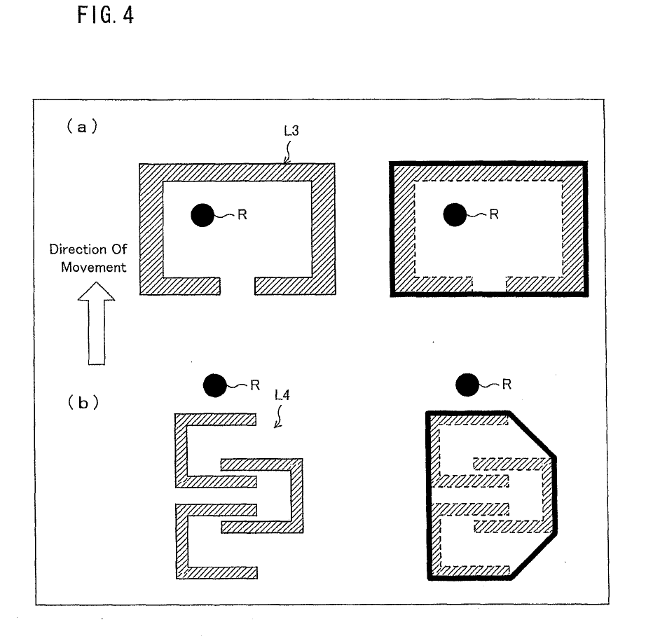

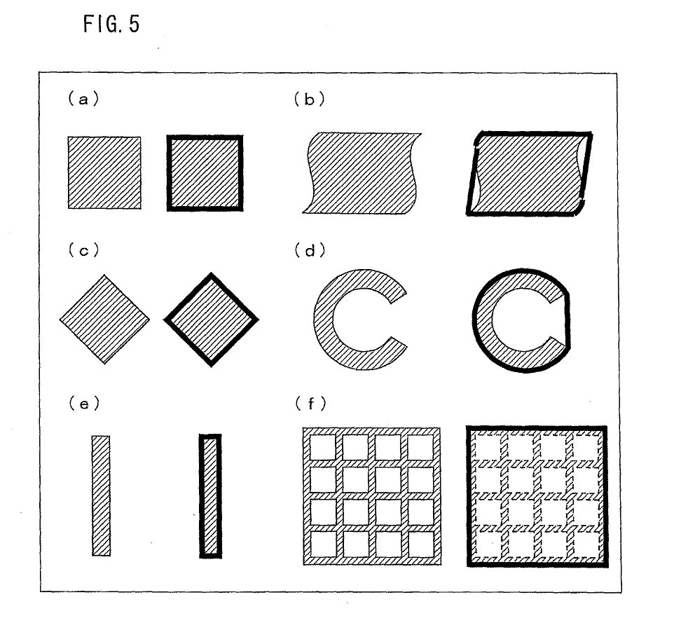

The hologram 13 causes the light guided by the lens to pass through so as to form, on a surface of a projection target, a projection pattern which at least partially has a continuous profile. FIG. 3 shows a lattice-shaped projection pattern. Note, however, that the projection pattern can be selected from various patterns, and this will be discussed below with reference to FIGS. 4 and 5.

FIG. 4 is an explanatory view for describing projection patterns. FIG. 4(a) is an explanatory view for describing a projection pattern L3 and a contour of the projection pattern L3. FIG. 4(b) is an explanatory view for describing a projection pattern L4 and a contour of the projection pattern L4. In FIGS. 4(a) and 4(b), parts shaded by oblique lines represent the projection patterns, and the contours of the respective projection patterns are indicated by thick lines. An arrow in FIG. 4 indicates a direction in which the projection patterns L3 and L4 move. Note that an object R represented by each of circles in FIG. 4 may be assumed to be, for example, an object that is present ahead of the vehicle 50 on a road. Each of the contours of the projection patterns is a minimum figure which can surround the entire projection pattern and has no depression.

In a case where the object R exists in a region defined by the contour of the projection pattern L3 (see FIG. 4(a)), the object R is surely irradiated with light even if the projection pattern L3 and/or the object R move(s). In other words, the object R never passes through the projection pattern L3 without crossing the contour of the projection pattern L3.

The same applies to FIG. 4(b). That is, in a case where the projection pattern L4 moves in a direction indicated by the arrow, the object R in FIG. 4(b) is surely irradiated with light emitted by the projection section 10 and changes the shape of the projection pattern L4.

FIG. 5 is an explanatory view for describing other projection patterns and contours of the respective projection patterns. FIG. 5(a) illustrates a quadrangular projection pattern. FIG. 5(b) illustrates a projection pattern having a shape defined by two straight lines and two curved lines. FIG. 5(c) illustrates a rhombic projection pattern. FIG. 5(d) illustrates a projection pattern having a shape of the alphabet “C”. FIG. 5(e) illustrates a rod-like projection pattern. FIG. 5(f) illustrates a lattice-shaped projection pattern. In FIGS. 5(a) through 5(f), parts shaded by oblique lines represent the projection patterns, and the contours of the respective projection patterns are indicated by thick lines. As illustrated in FIGS. 5(a) through 5(f), various projection patterns can be obtained by appropriately modifying the hologram 13.

Note that the projection patterns illustrated in FIGS. 4 and 5 are mere examples, and the shape of the projection pattern is not limited to a specific one, provided that the projection pattern, which at least partially has the continuous profile, can be formed on the surface of the projection target. Note that the projection section 10 may be provided on any of a front part, a rear part, and side parts of the vehicle 50.

It is preferable that a projection pattern is large enough to cover the entire object on a road. This allows the image capturing section 20 to capture an image containing the entire object so that the object in the image is analyzed by the image analyzing section 30.

It is preferable that the projection pattern is large enough to cover a region where the vehicle 50 passes through. This makes it possible to detect all events (such as an obstacle and unevenness) that will interfere with driving of the vehicle 50.

It is preferable that the projection pattern has a width or a length identical to or larger than that of the vehicle 50. This makes it possible to irradiate, with light, all objects that are likely to contact with the vehicle 50. It is therefore possible to prevent the vehicle 50 from colliding with such objects.

It is preferable that the projection pattern is projected as a single FIGURE. With the configuration, it is unnecessary to concurrently process a plurality of figures, and it is therefore possible to reduce an analysis load and an analysis time. The “single FIGURE” means a figure that (i) is not defined by a combination of a plurality of projection patterns each at least partially having a continuous profile but (ii) is defined by one (1) projection pattern.

It is preferable that the projection pattern has a shape that intersects, in at least one location, with an arbitrary straight line passing through a point which exists within a contour of the projection pattern.

In a case where some sort of event, which exists in the projection target, passes through an area within the contour of the projection pattern, the event is surely to intersect with the projection pattern when the event moves or the location of the projection pattern moves. Therefore, even in a case where the event in the projection target is a small object, it is possible to surely detect the small object as a change of the projection pattern, when the small object in the projection target and/or the projection pattern move(s).

A projection method with the use of light is not limited to the above-described method. For example, a galvanometer mirror or a DMD (digital mirror device) can be used.

It is preferable that the projection section 10 emits light so as to project the entire projection pattern on a surface of a projection target at a time.

For example, in a case where a surface of a projection target is irradiated with spotlight and a part of the surface irradiated with the spotlight is scanned, (i) it will take a while to grasp a peripheral situation of the vehicle 50 and of the projection target by the spotlight or (ii) the peripheral situation will not be grasped by the spotlight. In particular, in a case where the peripheral situation is an ever-changing situation, it is difficult to grasp the change of the peripheral situation by the spotlight.

On the other hand, the projection section 10 of the peripheral information generating apparatus 1 projects the entire projection pattern on the surface of the projection target at a time. This allows the peripheral information generating apparatus 1 to further surely grasp the peripheral situation of the peripheral information generating apparatus 1 and of the projection target by utilizing the projection pattern.

(Image Capturing Section)

The image capturing section 20 captures an image of a projection pattern formed on a surface of a projection target. For example, a camera is employed as the image capturing section 20. Examples of the camera encompass a moving-image capturing device for capturing a moving image at a television frame rate. The image capturing section 20 (i) starts capturing a moving image at a time point when the projection section 10 emits light and (ii) supplies the moving image to the image analyzing section 30.

Note here that a limit of detecting a change in shape of a projection pattern is determined in accordance with a pixel size, and the pixel size is determined in accordance with a resolution and an image-capturing range of an image capturing device. For example, in a case where the resolution is of a million (1000×1000) pixels and the image-capturing range is 5 m×5 m, the pixel size is 5 mm×5 mm.

In a case where the change in shape of the projection pattern is smaller than the pixel size, the image capturing section 20 cannot recognize the change in shape of the projection pattern. In other words, in a case where the image capturing section 20 captures an image of a projection pattern with the above resolution and in the above image capturing range, the image capturing section 20 can capture an image of the change in shape of the projection pattern, provided that the shape of the projection pattern is changed not less than 5 mm in a vertical or horizontal direction of the image capturing range.

(Image Analyzing Section)

The image analyzing section 30 analyzes a projection pattern in an image, which has been captured by the image capturing section 20, so as to generate peripheral information indicative of a peripheral situation of the peripheral information generating apparatus 1 and of a projection target.

Specifically, the image analyzing section 30 (i) receives, from the image capturing section 20, an image of the projection pattern which image has been captured by the image capturing section 20 and (ii) analyzes the projection pattern in the image. The following description will discuss, with reference to FIG. 1, how the image analyzing section 30 analyzes the projection pattern. First, the projection section 10 irradiates a road with light so that a projection pattern L is formed on the road. The projection pattern L has a quadrangular shape, and accordingly the projection pattern L on the road remains in the quadrangular shape while the vehicle 50 is running on a flat road. At the time, the image capturing section 20 captures an image, in a size of a×b, of the projection pattern L.

When the vehicle 50 comes near a slope (an upward slope in FIG. 1), the projection pattern L changes to a projection pattern L1 having a hexagonal shape. As shown in FIG. 1, the projection pattern L 1 has the hexagonal shape made up of (i) a trapezoid having two bases a and a₁ and a height (b−b₁) and (ii) a quadrangle obtained by a×b₁.

The image analyzing section 30 refers to a reference table stored in a memory (not illustrated). In the reference table, (i) the shape of the projection pattern L, (ii) a possible shape obtainable by changing the shape of the projection pattern L, (iii) a type of peripheral information obtained based on the change in shape, and (iv) an inclination (angle) of a slope indicated by a change amount (i.e., the size (such as a₁ and b₁) of the projection pattern L1), are associated with each other.

With reference to the reference table, the image analyzing section 30 analyzes the projection patterns L and L1 so as to determine (i) that the vehicle 50 comes near the upward slope and (ii) how much degree (angle) the upward slope is inclined, on the bases of (i) a change from the projection pattern L to the projection pattern L1 and (ii) the change amount.

Note that the reference table may be generated for each shape of a projection pattern. This allows the image analyzing section 30 to generate peripheral information indicative of a peripheral situation of the peripheral information generating apparatus 1 on the basis of the change in the shape of the projection pattern and the change amount, regardless of the shape of the projection pattern.

Most of projection targets such as a road and an obstacle have uneven surfaces. Moreover, the vehicle 50 moves up and down due to vibration while running. In a case where such an influence (noise) is included in an analysis result obtained by the image analyzing section 30, the image analyzing section 30 cannot generate accurate peripheral information. In order to avoid such a case, the image analyzing section 30 can be configured to eliminate the influence (noise) by ignoring a change in shape of a projection pattern, provided that the change indicates a change in height of not more than 5 mm. Note that an upper limit of the change in height which can be ignored may be appropriately modified depending on factors such as a condition of a road surface and a target to be detected.

(Analysis Time and Projection Location)

The following description will discuss how much time the image analyzing section 30 spends to analyze a captured image. Note that the light source 11 continuously emits light while the vehicle 50 is running, and therefore a time period required to emit light can be ignored here. That is, a time period required to generate peripheral information after the emission of light from the light source 11 is equal to a sum of (i) a time lag in capturing an image by the image capturing section 20 and (ii) a time period required for the image analyzing section 30 to analyze the captured image. Here, assuming that a frame rate of the image capturing section 20 is 30 fps, an image capturing interval is 33 ms and a time period required for processing the image is in a range of several tens of microseconds to 100 microseconds. Note that, in a case where the vehicle 50 runs at 60 km/h, the vehicle 50 runs 2 m to 3 m in 100 ms to 150 ms.

The following description will discuss a location in which a projection pattern is projected (hereinafter, the location is referred to as “projection location”). In a case where (i) the vehicle 50 runs at 60 km/h (i.e., it takes 0.06 second for the vehicle 50 to run 1 m) and (ii) the projection pattern is projected in a direction in which the vehicle 50 runs, a projection location is determined based on a distance between (i) a part of the projection pattern which part is closest to the vehicle 50 and (ii) the vehicle 50.

First, the following description will discuss where to project the projection pattern for avoiding an obstacle. It is generally said that it takes 0.8 second (running of 13 m) for a driver to start avoiding an obstacle after recognizing the obstacle. It is also said that a minimum distance necessary for the driver to successfully avoid an obstacle is 12 m from the obstacle. Under the circumstances, in order to avoid the obstacle while driving the vehicle 50, it is necessary to project the projection pattern in a location that is 25 m distant from the vehicle 50.

Note, however, that, in a case where (i) an obstacle is to be avoided by an automatic control and (ii) a time period from when the obstacle is detected and to when the automatic control is started is substantially equal to the time period required for the image analyzing section 30 to analyze a captured image, the projection pattern may be projected in a location that is 14 m (12 m (above described)+2 m) distant from the vehicle 50.

Next, the following description will discuss a projection location set in a case where peripheral information on an inclination of a road is generated. In a case where (i) gears of the vehicle 50 are automatically adjusted when an inclination of a road is detected and (ii) a time period required to change the gears is substantially equal to the time period required for the image analyzing section 30 to analyze a captured image, it is preferable that the projection location is 2 m distant from the vehicle 50.

The following description will discuss a projection location which is set so that a width of a narrow road is detected for avoiding running off the road or colliding with a wall. In a case where (i) the vehicle 50 runs on the narrow road at 30 km/h, (ii) it takes 0.8 second (running of 6.5 m) for the driver to start the avoidance, as with the case of running at 60 km/h, and (iii) a minimum distance necessary for the driver to successfully carry out the avoidance is 6 m (which is half of the case of running at 60 km/h), it is preferable that the projection location is distant from 12.5 m to 13 m, based on 6.5 m+6 m=12.5 m.

As such, the projection location in which the projection pattern is to be projected varies as appropriate in accordance with a purpose such as avoidance of an obstacle or detection of an inclination of a road. Note, however, that it is preferable for safety that the projection location is distant from the vehicle 50 by a distance obtained by adding 3 m to each of the above described distances, in consideration of a factor such as a time lag in image-capturing caused by the image capturing section

(Vehicle in which Peripheral Information Generating Apparatus is Mounted)

The following description will discuss the operation controlling section 60 and the output section 70 included in the vehicle 50, with reference to FIG. 2.

As early described, the image analyzing section 30 generates peripheral information and then supplies the peripheral information to the operation controlling section 60. Upon receipt of the peripheral information, the operation controlling section 60 controls, in accordance with a content of the peripheral information, at least one of a speed of the vehicle 50, a direction in which the vehicle 50 runs, and an issuing of a warning.

For example, in a case where the image analyzing section 30 generates peripheral information indicating that there is an upward slope in a direction in which the vehicle 50 is running, the operation controlling section 60 automatically changes gears in accordance with the inclination (angle) of the upward slope which inclination is contained in the peripheral information. This allows the vehicle 50 to enter the upward slope at an appropriate speed and with an appropriately adjusted gear.

Alternatively, in a case where the image analyzing section 30 generates peripheral information of something (such as an obstacle existing in the direction in which the vehicle 50 is running) which requires an evasive action, the operation controlling section 60 automatically changes the direction, in which the vehicle 50 is running, in order to secure a safe driving. This allows the vehicle 50 to avoid, for example, an obstacle that is present ahead of the vehicle 50.

In a case where the operation controlling section 60 receives, from the image analyzing section 30, peripheral information of an event (such as existence of an obstacle in a direction in which the vehicle 50 is running) that requires giving a warning to a driver of the vehicle 50, the operation controlling section 60 supplies the peripheral information to the output section 70. Upon receipt of the peripheral information, the output section 70 gives the driver a visual and/or audio warning(s) such as “obstacle ahead of you” or “road width is getting narrower”. This makes it possible to warn the driver at an appropriate timing so that the driver can keep safe driving. Note that examples of the output section 70 encompass a car navigation system, a display device, and a speaker.

The peripheral information generating apparatus 1 can thus improve safety of the vehicle 50 in cooperation with the operation controlling section 60 and the output section 70. Note that each of the operation controlling section 60 and the output section 70 may be incorporated in the peripheral information generating apparatus 1.

(Method for Generating Peripheral Information)

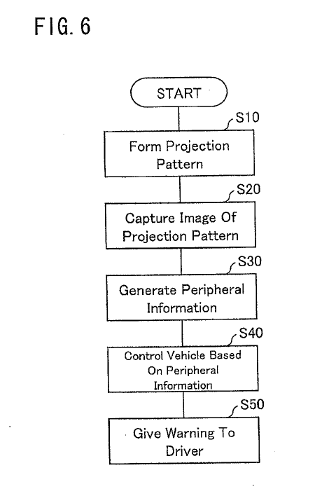

The following description will discuss a method for generating peripheral information, with reference to FIG. 6. FIG. 6 is a flowchart for describing the method for generating peripheral information.

First, in S10, the projection section 10 irradiates a projection target with light so as to form, on a surface of the projection target, a projection pattern that at least partially has a continuous profile.

Then, in S20, the image capturing section 20 captures an image of the projection pattern formed on the surface of the projection target by the projection section 10.

Subsequently, in S30, the image analyzing section 30 (i) analyzes the projection pattern in the image captured by the image capturing section 20 and (ii) generates peripheral information indicative of a peripheral situation of a vehicle 50 and the projection target.

Then, in S40, the operation controlling section 60 controls a speed, a running direction, and the like of the vehicle 50 in accordance with the peripheral information received from the image analyzing section 30.

In S50, the output section 70 (i) receives, from the operation controlling section 60, peripheral information of an event that requires giving a warning to a driver of the vehicle 50 and (ii) gives the warning to the driver based on the peripheral information.

The peripheral information generating apparatus 1 thus generates peripheral information. The peripheral information generating apparatus 1 can improve safety of the vehicle 50 in cooperation with the operation controlling section 60 and the output section 70 on the basis of the peripheral information thus generated.

The following description will discuss Examples of the peripheral information generating apparatus 1 with reference to FIG. 1 and so forth. Note that explanations of configurations, etc. which have already been described above are omitted in Examples below. Moreover, Examples below discuss the peripheral information generating apparatus 1 which is mounted in the vehicle 50.

### Example 1

FIG. 1 is an explanatory view for describing an operation of the peripheral information generating apparatus 1 which is mounted in the vehicle 50.

The projection section 10 of the peripheral information generating apparatus 1 mounted in the vehicle 50 emits, in a direction in which the vehicle 50 runs, light having a wavelength falling within an infrared region or an ultraviolet region (i.e., a wavelength of not more than 400 nm or of not less than 700 nm) so as to project, on a road, a projection pattern L having a quadrangular shape. When the vehicle 50 comes near a slope (an upward slope in FIG. 1), the projection pattern L changes to a projection pattern L1 having a hexagonal shape. In FIG. 1, the projection pattern L1 has the hexagonal shape made up of (i) a trapezoid having bases a and a₁ and a height (b−b₁) and

(ii) a quadrangle obtained by a×b₁.

Subsequently, the peripheral information generating apparatus 1 (i) captures an image of the projection pattern L1, and (ii) determines, by analyzing the image, (a) that the vehicle 50 is coming near the upward slope and (b) how much degree (angle) the upward slope is inclined, on the basis of (i) the change from the projection pattern L to the projection pattern L1 and (ii) an amount of the change. The peripheral information generating apparatus 1 then generates, based on the analysis results, peripheral information indicative of a peripheral situation of the peripheral information generating apparatus 1.

Upon receipt of the peripheral information, the operation controlling section 60 may automatically change the gears of the vehicle 50 in accordance with the inclination (angle) of the upward slope, which inclination (angle) is contained in the peripheral information. This allows the vehicle 50 to enter the upward slope at an appropriate speed and with an appropriately adjusted gear.

Example 1 brings about the following advantages.

The projection pattern L has a quadrangular shape occupying a certain area. Therefore, the peripheral information generating apparatus 1 can continuously (i) carry out an image analysis and (ii) generate peripheral information. This allows the peripheral information generating apparatus 1 to start carrying out an image analysis even immediately after the vehicle 50 comes near a slope (inclination).

Most of projection targets such as a road and an obstacle have uneven surfaces. Moreover, the vehicle 50 moves up and down due to vibration while running. In a case where such an influence (noise) is included in an analysis result obtained by the image analyzing section 30, the image analyzing section 30 cannot generate accurate peripheral information. In order to avoid such a case, the image analyzing section 30 eliminates the influence (noise) by ignoring a change in shape of a projection pattern, which change indicates a change in height of not more than 5 mm. This allows the peripheral information generating apparatus 1 to minimize an analysis error caused by unevenness of a road surface.

The inclination (angle) of a slope is analyzed on the basis of an amount of change in shape of the projection pattern. This allows the periphery information generating apparatus 1 to carry out an analysis without being affected by factors such as (i) a noise caused by slight unevenness of a road surface and (ii) minute distortion of the projection pattern caused by unevenness.

In contrast, in a case where a projection pattern is a spot, image analysis is carried out with reference to the spot. Therefore, in a case where unevenness exists in a point (spot) to be projected, an analysis error occurs, and the analysis error cannot be eliminated. Moreover, since the projection pattern is the spot, the image analysis cannot be surely carried out immediately after the vehicle 50 comes near a slope. On this account, the periphery information generating apparatus 1 can improve analysis accuracy, as compared with the case where the projection pattern is the spot.

In a case where the projection pattern is in the shape of a quadrangular frame (see FIG. 1), analysis can be carried out with respect also to an inclination in a lateral direction of the vehicle 50. It is therefore possible to stabilize movement of the vehicle 50 by, for example, controlling driving force to be applied to wheels of the vehicle 50 in accordance with the inclination. Further, since the projection pattern is in the frame shape, an area to be irradiated with light can be reduced, and accordingly an amount of light to be emitted can also be reduced. Note that the shape of the projection pattern is not limited to the quadrangular frame shape as illustrated in FIG. 1 but the shape of the projection pattern may be any of other shapes such as those illustrated in FIG. 4 and so forth.

Note that the wavelength of light projected by the projection section 10 is not limited to the wavelengths falling within the infrared region or the ultraviolet region. Note also that the projection section 10 may be provided in an arbitrary suitable part of the vehicle 50.

### Example 2

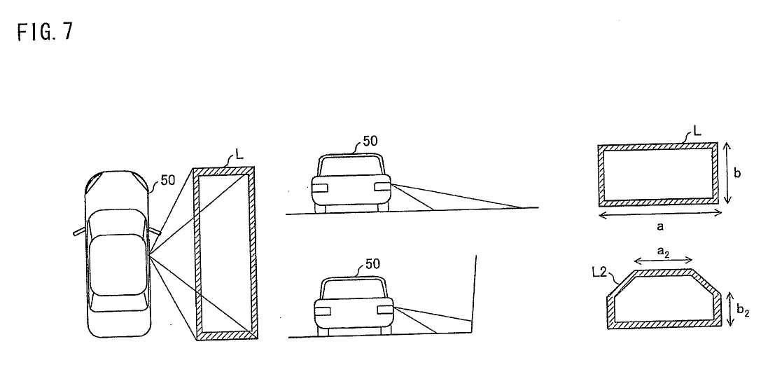

FIG. 7 is an explanatory view for describing another operation of the peripheral information generating apparatus 1 mounted in the vehicle 50.

The projection section 10 of the peripheral information generating apparatus 1 mounted in the vehicle 50 emits light having an arbitrary wavelength in a side direction of the vehicle 50 so as to project a projection pattern L having a quadrangular shape on a road. In a case where a wall appears next to the vehicle 50, the projection pattern L changes to a projection pattern L2 having a hexagonal shape. In FIG. 7, the projection pattern L2 has a hexagonal shape made up of (i) a trapezoid having bases a and a₂ and a height (b−b₂) and (ii) a quadrangle obtained by a×b₂.

The peripheral information generating apparatus 1 (i) captures an image of the projection pattern L2 and (ii) determines, by analyzing the image, (a) that a wall, a side ditch, or the like exists next to the vehicle 50, (b) how far the vehicle 50 is distant from the wall, the side ditch, or the like, and (c) how much degree the wall, the side ditch, or the like is inclined, on the basis of (i) the change from the projection pattern L to the projection pattern L2 and (ii) an amount of the change. The peripheral information generating apparatus 1 generates peripheral information indicative of a peripheral situation of the peripheral information generating apparatus 1 on the basis of the analysis results.

Specifically, the image analyzing section 30 refers to a reference table stored in a memory (not illustrated). In the reference table, various items are associated with each other. Examples of such items encompass (i) a shape of the projection pattern L, (ii) a possible shape obtained by changing the shape of the projection pattern L, (iii) a type of peripheral information obtained based on the change in shape, (iv) a distance between the vehicle 50 and the wall, the side ditch, or the like, which distance is obtained based on an amount of the change (i.e., a size (such as a₂ and b₂) of the projection pattern L2), and (v) an inclination of the wall, the side ditch, or the like, which inclination is also obtained based on the amount of the change.

With reference to the reference table, the image analyzing section 30 determines, by analyzing the image, (i) that a wall, a side ditch, or the like exists next to the vehicle 50, (ii) how far the vehicle 50 is distant from the wall, the side ditch, or the like, and (iii) how much degree the wall, the side ditch, or the like is inclined, on the basis of (i) the change from the projection pattern L to the projection pattern L2 and (ii) the amount of the change.

Note that the reference table may be prepared for each of shapes of projection patterns. This allows the image analyzing section 30 to generate peripheral information indicative of a peripheral situation of the peripheral information generating apparatus 1 on the basis of a change in shape of a projection pattern and an amount of the change, regardless of the shape of the projection pattern.

It is preferable that the projection pattern is in the shape of the quadrangular frame illustrated in FIG. 7 because the projection pattern having such a shape can detect a wide range while (i) reducing an area to be irradiated with light and accordingly (ii) reducing an amount of light to be emitted. Note, however, that the shape of the projection pattern may be any of other shapes such as those illustrated in FIG. 4 and so forth.

In Example 2, upon receipt of the peripheral information, the operation controlling section 60 provided in the vehicle 50 may carry out a control to give, to a driver of the vehicle 50, a warning for preventing (i) collision with a wall or (ii) running off a road, in accordance with a distance between the vehicle 50 and the wall or a side ditch, which distance is contained in the peripheral information.

The projection section 10 of the peripheral information generating apparatus 1 mounted in the vehicle 50 may emit light in left and right directions of the vehicle 50. With the configuration, in a case where the vehicle 50 is running on a narrow one-way road, the operation controlling section 60 can control the vehicle 50 to automatically run in the center of the narrow one-way road.

### Example 3

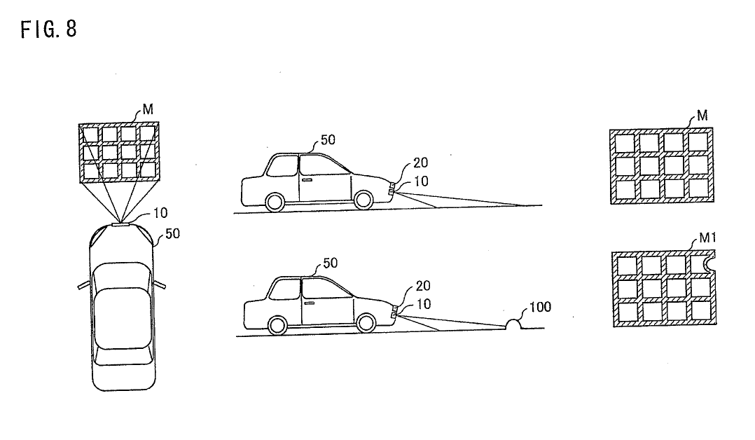

FIG. 8 is an explanatory view for describing yet another operation of the peripheral information generating apparatus 1 mounted in the vehicle 50.

The projection section 10 of the peripheral information generating apparatus 1 mounted in the vehicle 50 emits, in a direction in which the vehicle 50 runs, light with an arbitrary wavelength so as to project, on a road, a projection pattern M having a lattice shape. In a case where an obstacle appears ahead of the vehicle 50, the projection pattern M changes to a projection pattern M1 which has been obtained by partially changing the shape of the projection pattern M.

Subsequently, the peripheral information generating apparatus 1(i) captures an image of the projection pattern M1 and (ii) determines, by analyzing the image, (a) that an obstacle exists ahead of the vehicle 50, (b) how large the obstacle is, and (c) where the obstacle is located, on the basis of (i) the change from the projection pattern M to the projection pattern M1 and (ii) an amount of the change. The peripheral information generating apparatus 1 generates peripheral information indicative of a peripheral situation of the peripheral information generating apparatus 1 on the basis of the analysis results.

Specifically, the image analyzing section 30 refers to a reference table stored in a memory (not illustrated). In the reference table, various items are associated with each other. Examples of such items encompass (i) a shape of the projection pattern M, (ii) a possible shape obtained by changing the shape of the projection pattern M, (iii) a type of peripheral information obtained based on the change in shape, and (iv) a size and a location of an obstacle which size and location are indicated by an amount of the change (i.e., a degree of distortion of the projection pattern M).

With reference to the reference table, the image analyzing section 30 determines (i) that an obstacle exists ahead of the vehicle 50 on the road, (ii) the size of the obstacle, and (iii) the location of the obstacle, on the basis of (a) the change from the projection pattern M to the projection pattern M1 and (b) the amount of the change.

Note that the reference table may be prepared for each of shapes of projection patterns. This allows the image analyzing section 30 to generate peripheral information indicative of a peripheral situation of the peripheral information generating apparatus 1 on the basis of a change in shape of a projection pattern and an amount of the change, regardless of the shape of the projection pattern.

It is preferable that the projection pattern is in the lattice shape as illustrated in FIG. 8 because the projection pattern having such a shape allows (i) detection over a wide range and (ii) generation of detailed information indicative of a location of an obstacle. Note, however, that the shape of the projection pattern may be any of other shapes such as those illustrated in FIG. 4 and so forth. Moreover, the lattice shape does not need to be made up of only straight lines but can partially be made up of a curved line(s). Further, Example 3 is applicable also to detection of unevenness of a road surface, in addition to detection of an obstacle existing on the road.

Example 3 brings about the following advantages.

The projection pattern M has a lattice shape surrounded by straight lines or curved lines. By employing the projection pattern M having such a shape, the peripheral information generating apparatus 1 can (i) detect a small obstacle or unevenness of a road surface and (ii) recognize a state where a target (such as an obstacle or an uneven surface of a road) is moving in a projection range. Further, the peripheral information generating apparatus 1 employing the projection pattern M can also recognize (i) how and how fast a detected target passes through the projection pattern M from left to right or vice versa and (ii) whether or not the vehicle 50 can avoid the detected target.

In Example 3, the projected range may be arbitrarily determined, and it is unnecessary to emit light as broad as possible in a direction in which the vehicle 50 runs. This allows a reduction in amount of analysis carried out by the image analyzing section 30. Therefore, the peripheral information generating apparatus 1 can detect an obstacle or unevenness on a road while reducing an analysis load and an analysis time.

According to the above description, the projection pattern M is projected in the direction in which the vehicle 50 runs. Note, however, that the direction in which the projection pattern M is projected is not limited to this, and the projection pattern M may be projected in any directions from the vehicle 50. By modifying the projection direction, the peripheral information generating apparatus 1 can detect an approach of another vehicle, a passer-by, etc. to a side of the vehicle 50. In a case where, for example, the projection pattern M is set to be projected behind the vehicle 50, the vehicle 50, which is backing for parking, can avoid an obstacle on a road or a child who has suddenly darted out. It is therefore possible to help the vehicle 50 to park.

### Example 4

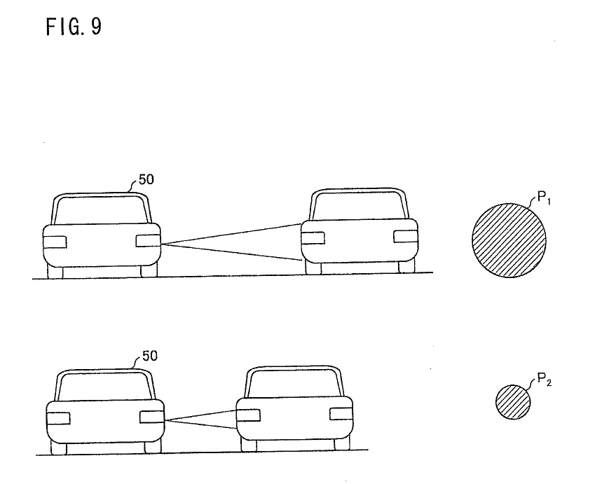

FIG. 9 is an explanatory view for describing yet another operation of the peripheral information generating apparatus 1 mounted in the vehicle 50.

The projection section 10 of the peripheral information generating apparatus 1 mounted in the vehicle 50 emits light, which has an arbitrary wavelength, not only to a road but also to a periphery of the vehicle 50. In this case, the projection section 10 projects a circular projection pattern on a surface of a projection target. The projection pattern changes in size in accordance with a distance between the vehicle 50 and the projection target. In FIG. 9, a projection pattern P₁ is reduced in size to a projection pattern P₂ as the distance between the vehicle 50 and the projection target (i.e., another vehicle) gets shorter.

Subsequently, the peripheral information generating apparatus 1 (i) captures and image of the projection pattern P₂ and (ii) determines, by analyzing the image, (a) that an object exists in a direction in which light is emitted, (b) a location of the object, and (c) a speed at which the object moves, on the basis of (i) the size of the projection pattern P₂, (ii) a change from the projection pattern P₁ to the projection pattern P₂ (or vice versa), and (iii) an amount of the change. The peripheral information generating apparatus 1 then generates peripheral information indicative of a peripheral situation of the peripheral information generating apparatus 1 on the basis of the analysis results.

Specifically, the image analyzing section 30 refers to a reference table stored in a memory (not illustrated). In the reference table, items such as (i) a shape of the projection pattern P, (ii) a possible shape obtained by changing the projection pattern P, (iii) a type of peripheral information obtained based on the change in shape, and (iv) an amount of the change in shape (i.e., change in size of the projection pattern P, time required for the change in size), are associated with a distance between the vehicle 50 and the object, a speed at which the object moves, and the like.

With reference to the reference table, the image analyzing section 30 determines, for example, (i) the location of the object which is the projection target and (ii) the speed at which the object moves, on the basis of (i) the size of the projection pattern P₂, (ii) the change from the projection pattern P₁ to the projection pattern P₂ (or vice versa), and (iii) the amount of the change.

Note that the reference table may be prepared for each of shapes of projection patterns. This allows the image analyzing section 30 to generate peripheral information indicative of a peripheral situation of the peripheral information generating apparatus 1 on the basis of a change in shape of the projection pattern and an amount of the change, regardless of the shape of the projection pattern.

Upon receipt of the peripheral information, the operation controlling section 60 may control the vehicle 50 to give a warning to a driver of the vehicle 50 or to surroundings of the vehicle 50 so that a collision can be avoided.

Example 4 brings about the following advantages.

It is possible to appropriately select a range and a shape of the projection pattern for the peripheral information generating apparatus 1. Therefore, the peripheral information generating apparatus 1 can form the projection pattern on a surface of an object which is located above or obliquely above the vehicle 50. That is, the peripheral information generating apparatus 1 can obtain peripheral information of any directions from the vehicle 50. It is therefore unnecessary to provide a plurality of projection sections 10 in the peripheral information generating apparatus 1, that is, it is satisfactory for the peripheral information generating apparatus 1 to include just one (1) projection section 10.

Further, the peripheral information generating apparatus 1 can accurately grasp the distance between the projection target object and the vehicle 50, on the basis of the size of the projection pattern. Therefore, it is possible to warn the driver of an approach of an object at an appropriate timing by configuring the peripheral information generating apparatus 1 to issue a warning only in a case where the shape of the projection pattern becomes larger than a predetermined size.

Further, it is possible to analyze a moving speed of an object on which a projection pattern is formed, by measuring time required for the change from the projection pattern P₁ to the projection pattern P₂ (or vice versa). It is therefore possible to warn the driver of an approach of an object at an appropriate timing by configuring the peripheral information generating apparatus 1 to issue a warning only a case where the moving speed becomes greater than a predetermined speed.

The peripheral information generating apparatus 1 may generate peripheral information indicating that an object, on which a projection pattern is formed, is distant from the vehicle 50 by not less than a predetermined distance, on the basis of an analysis result brought by the image analyzing section 30. In this case, it is possible to carefully select peripheral information to be provided to the driver by configuring the peripheral information generating apparatus 1 not to provide, to the driver, such peripheral information indicating that the object is distant from the vehicle 50 by not less than the predetermined distance.

The peripheral information generating apparatus 1 may be configured to employ a projection pattern whose entire shape is recognized from a part of the projection pattern.

In this case, the projection pattern has, for example, a shape of a circle or of a part of a circle, and the entire shape of the projection pattern having such a shape is recognized from a part of the projection pattern. Therefore, by employing such a projection pattern, the entire shape of the projection pattern can be recognized from the part of the projection pattern, even in a case where mere the part of the projection pattern is formed on a surface of a projection target.

Therefore, even in the case where mere the part of the projection pattern is formed on the surface of the projection target, the image analyzing section 30 can generate information indicative of a distance between the peripheral information generating apparatus 1 and the projection target on the basis of the size of the projection pattern.

In view of this, it is preferable that the projection pattern has a circular shape. Note, however, that the shape of the projection pattern is not limited to this, and the shape of the projection pattern may be any of other shapes such as those illustrated in FIG. 4 and so forth.

### Example 5

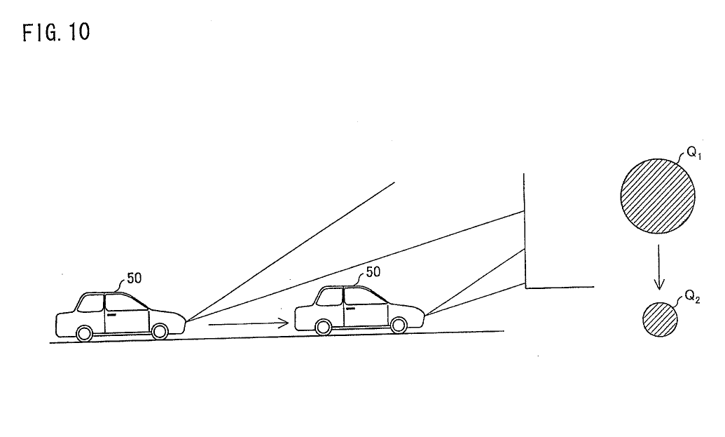

FIG. 10 is an explanatory view for describing yet another operation of the peripheral information generating apparatus 1 mounted in the vehicle 50.

The projection section 10 of the peripheral information generating apparatus 1 mounted in the vehicle 50 emits light having an arbitrary wavelength obliquely above with respect to the direction in which the vehicle 50 runs, so as to form a projection pattern having a circular shape on a surface of a projection target (a wall in FIG. 10). The projection pattern changes in size in accordance with a distance between the vehicle 50 and the projection target. In FIG. 10, a projection pattern Q₁ is changed to a projection pattern Q₂. Note here that the shape of the projection pattern is not limited to the circular shape but may be any of other shapes such as those illustrated in FIG. 4 and so forth.

The peripheral information generating apparatus 1 captures an image of the projection pattern Q₂, and determines, by analyzing the image, (i) that there is an object in the direction in which the projection section 10 emits light and (ii) a height of the object, on the basis of (a) whether or not the projection pattern Q₂ is present and (b) the size of the projection pattern Q₂. The peripheral information generating apparatus 1 generates peripheral information indicative of a peripheral situation of the peripheral information generating apparatus 1 on the basis of the analysis result.

Specifically, the image analyzing section 30 refers to a reference table stored in a memory (not illustrated). In the reference table, (i) a shape of the projection pattern Q, (ii) a type of peripheral information obtained from the shape of the projection pattern Q, and (iii) a size of the projection pattern Q, are associated with a height of the object.

With reference to the reference table, the image analyzing section 30 analyzes the height of the object, which is the projection target, on the basis of the size of the projection pattern Q₂. Note here that it can be precisely said that the “height of the object” is a distance, in the gravitational direction, between the object and the vehicle 50.

Note that the reference table may be prepared for each of shapes of projection patterns. This allows the image analyzing section 30 to generate peripheral information indicative of a peripheral situation of the peripheral information generating apparatus 1 on the basis of the shape of the projection pattern, regardless of the shape of the projection pattern.

The peripheral information generating apparatus 1 may be configured to employ a projection pattern whose entire shape is recognized from a part of the projection pattern.

In this case, the projection pattern has, for example, a shape of a circle or of a part of a circle, and the entire shape of the projection pattern having such a shape is recognized from a part of the projection pattern. Therefore, by employing such a projection pattern, the entire shape of the projection pattern can be recognized from the part of the projection pattern, even in a case where mere the part of the projection pattern is formed on a surface of a projection target.

Therefore, even in the case where mere the part of the projection pattern is formed on the surface of the projection target, the image analyzing section 30 can generate information indicative of the height of an object on the basis of the size of the projection pattern.

In view of this, it is preferable that the projection pattern has a circular shape. Note, however, that the shape of the projection pattern is not limited to this, and the shape of the projection pattern may be any of other shapes such as those illustrated in FIG. 4 and so forth.

In a case where the vehicle 50 will possibly collide with an object because the vehicle 50 is close to the object, the operation controlling section 60, which has received the peripheral information, may control the vehicle 50 to give a warning to a driver of the vehicle 50 or to surroundings of the vehicle 50 so that the collision with the object can be avoided. Specifically, the warning can be set to be given only in a case where the shape of the projection pattern becomes smaller than a predetermined size. Moreover, the predetermined size can be adjusted appropriately in accordance with a height of the vehicle 50.

### Other Application

The above description has discussed a case where the peripheral information generating apparatus 1 is mounted in the vehicle 50. Note, however, that the present invention is not limited to the case. The peripheral information generating apparatus 1 may be mounted in any of conveyances (such as two-wheeled vehicles, four-wheeled vehicles, train, ship, and aircraft) or in an illumination device such as a lighthouse.

Further, the vehicle 50 or the like can have a configuration in which the above Examples are combined as appropriate.

### Other Expression of Embodiment

The peripheral information generating apparatus of the present embodiment may include (i) a light irradiation section for irradiating an irradiation target with light that forms an irradiation shape having a sequence of contours, (ii) an image capturing section for capturing an image of reflected light reflected from the irradiation target, (iii) image processing means for extracting a reflection shape defined by the reflected light in the image captured by the image capturing section, and (iv) detecting means for detecting peripheral information of the peripheral information generating apparatus from the reflection shape.

[Main Points]

In order to attain the object, a peripheral information generating apparatus in accordance with an aspect of the present invention may include a projection section for forming a projection pattern, which at least partially has a continuous profile, on a surface of a projection target by irradiating the projection target with light; an image capturing section for capturing an image of the projection pattern formed on the surface; and an image analyzing section for generating peripheral information, which indicates a peripheral situation of the peripheral information generating apparatus and of the projection target, by analyzing the projection pattern in the image captured by the image capturing section.

In order to attain the object, a method for generating peripheral information in accordance with an aspect of the present invention includes the steps of: (a) forming a projection pattern, which at least partially has a continuous profile, on a surface of a projection target by irradiating the projection target with light; (b) capturing an image of the projection pattern formed on the surface in the step (a); and (c) generating peripheral information, which indicates a peripheral situation of the projection target, by analyzing the projection pattern in the image captured in the step (b).

According to the configuration, the image analyzing section (the step (c)) generates the peripheral information, which indicates a peripheral situation of the peripheral information generating apparatus and of the projection target, by analyzing the projection pattern in the image captured by the image capturing section (the step (b)). In this case, the projection pattern, whose image is captured by the image capturing section, at least partially has a continuous profile.

With the configuration, in a case where any sort of event (e.g., unevenness of a surface, an inclination, or presence of an obstacle) exists in an image-captured range, such an event immediately changes a shape of the projection pattern which at least partially has the continuous profile. Moreover, since the projection pattern at least partially has the continuous profile, it is possible to grasp presence of an event with higher accuracy, as compared with a case where the projection pattern has a shape of, for example, a point (spot). Note here that the “event” can be something that indicates a peripheral situation of the peripheral information generating apparatus. Moreover, the “continuous profile” indicates a shape formed by straight lines and/or curved lines.

According to the configuration of the present invention, the image analyzing section (the step (c)) can generate, quickly and highly accurately, the peripheral information, which indicates a peripheral situation of the projection target, by analyzing the projection pattern.

In the peripheral information generating apparatus in accordance with an aspect of the present invention, it is possible that, in a case where at least one of (i) an event in the projection target and (ii) the projection pattern moves, the image analyzing section generates the peripheral information for each of all events that pass through a contour of the projection pattern.

According to the configuration, the image analyzing section can generate the peripheral information for each of all events that pass through the contour of the projection pattern. This allows the peripheral information generating apparatus of the present invention to surely grasp presence of an event that indicates a peripheral situation of the peripheral information generating apparatus.

Note that the “contour” of the projection pattern indicates a minimum figure which can surround the entire pattern and has no depression.

In the peripheral information generating apparatus in accordance with an aspect of the present invention, it is possible that the projection pattern intersects, in at least one location, with an arbitrary straight line passing through a point which exists within the contour of the projection pattern.

According to the configuration, in a case where (i) there exists some sort of event (e.g., an obstacle or unevenness) in the projection target and (ii) the event passes through the contour of the projection pattern when the event moves or when a location of the projection pattern moves, the event will surely intersect with the projection pattern.

Therefore, the peripheral information generating apparatus of the present invention brings about an effect of surely generating information regarding an event in the projection target, in a case where at least one of (i) the event in the projection target and (ii) the projection pattern moves.

In the peripheral information generating apparatus in accordance with an aspect of the present invention, it is possible that the projection pattern has at least one of a lattice shape and a closed continuous profile.

The projection pattern can have any of various shapes. With any of such various shapes, it is possible to generate the peripheral information indicative of the peripheral situation of the peripheral information generating apparatus and of the projection target.

In the peripheral information generating apparatus in accordance with an aspect of the present invention, it is possible that the projection section emits the light so that the projection pattern is wholly projected on the surface at a time.

For example, in a case where the surface of the projection target is irradiated with spotlight and a part of the surface irradiated with the spotlight is scanned, (i) it will take a while to grasp a peripheral situation of the peripheral information generating apparatus and of the projection target by the spotlight or (ii) the peripheral situation will not be grasped by the spotlight. In particular, in a case where the peripheral situation is an ever-changing situation, it is difficult to grasp the change of the peripheral situation by the spotlight.

On the other hand, according to the peripheral information generating apparatus in accordance with an aspect of the present invention, the projection section projects the projection pattern so that the entire projection pattern is projected on the surface at a time. This allows the peripheral information generating apparatus to further surely grasp the peripheral situation of the peripheral information generating apparatus and of the projection target by the projection pattern. Therefore, the peripheral information generating apparatus of the present invention can generate the peripheral information quickly and highly accurately.

In the peripheral information generating apparatus in accordance with an aspect of the present invention, it is possible that the image analyzing section generates, as the peripheral information, information indicative of a shape of the projection target based on a distortion of the projection pattern in the image.

When a projection target is irradiated with light, a shape of a projection pattern is determined by a shape of the projection target. In view of this, by associating a distortion of the projection pattern with a shape of the projection target in advance, the image analyzing section can generate information indicative of a shape of the projection target based on a distortion of the projection pattern. Note that such association of the distortion with the shape may be carried out by a general method using a look-up table or the like.

In the peripheral information generating apparatus in accordance with an aspect of the present invention, it is possible that the image analyzing section generates, as the peripheral information, information indicative of a distance between the peripheral information generating apparatus and the projection target based on a size of the projection pattern in the image.

In general, as a distance between a light source and an image-captured target becomes larger, a shape of a projection pattern formed on a surface of the image-captured target tends to become larger in size. By utilizing such a tendency, the image analyzing section can generate information indicative of a distance between the peripheral information generating apparatus and the projection target by associating a distance between the peripheral information generating apparatus and the image-captured target with a size of the projection pattern in advance.

Note that such association of the distance with the size may be carried out by a general method using a look-up table or the like.

In the peripheral information generating apparatus in accordance with an aspect of the present invention, it is possible that an entire shape of the projection pattern is recognized from a part of the projection pattern.

In this case, the projection pattern has, for example, a shape of a circle or of a part of a circle, and the entire shape of the projection pattern having such a shape is recognized from a part of the projection pattern.

Therefore, by employing such a projection pattern, the entire shape of the projection pattern can be recognized from the part of the projection pattern, even in a case where mere the part of the projection pattern is formed on the surface of the projection target.

Therefore, even in the case where mere the part of the projection pattern is formed on the surface of the projection target, the image analyzing section can generate information indicative of a distance between the peripheral information generating apparatus and the projection target on the basis of the size of the projection pattern.

In the peripheral information generating apparatus in accordance with an aspect of the present invention, it is possible that the light has a long or short wavelength different from that of sunlight.

According to the configuration, in a case where a member (such as a film) for blocking a wavelength of the sunlight is employed, the image capturing section can recognize a projection pattern even with the use of low-power light. Further, by using such a member for blocking a wavelength of the sunlight, the image capturing section can eliminate a noise caused by reflection of the sunlight, when the image capturing section captures an image.

In the peripheral information generating apparatus in accordance with an aspect of the present invention, it is possible that the light has a wavelength which falls within an infrared region or within an ultraviolet region.

According to the configuration, the projection pattern is invisible to naked eyes. Therefore, scenery is not spoiled even in a case where the projection pattern is formed.

In the peripheral information generating apparatus in accordance with an aspect of the present invention, it is possible that the light has a wavelength which falls within a visible region.

According to the configuration, the projection pattern is visible to naked eyes, and therefore, in a case where the peripheral information generating apparatus of the present invention is mounted in, for example, an automobile, it is possible to make others such as other vehicles and passers-by aware of the presence of the automobile through the visualization of the projection pattern. This makes it possible to improve traffic safety.

In the peripheral information generating apparatus in accordance with an aspect of the present invention, it is possible that the projection section projects the projection pattern with use of a laser beam.

The laser beam has a high directivity and is suitable for being propagated through long distance. The projection section can irradiate a projection target, which is distant from the projection section, with a laser beam by utilizing the advantageous features of the laser beam, i.e., by forming a projection pattern on a surface of the projection target by the use of the laser beam. It is therefore possible to irradiate a projection target, which is distant from the peripheral information generating apparatus, with light, and accordingly more pieces of peripheral information can be generated.

A conveyance in accordance with an aspect of the present invention can include any of the above described peripheral information generating apparatuses.

The peripheral information generating apparatus of the present invention can be suitably mounted in a conveyance.

Note that examples of the conveyance encompass a two-wheeled vehicle such as a motorcycle, a four-wheeled vehicle such as an automobile, a train, a ship, and an aircraft.

The conveyance in accordance with an aspect of the present invention can further include an operation controlling section for controlling at least one of a speed at which the conveyance moves, a direction in which the conveyance moves, and issuing of a warning, in accordance with obtained peripheral information which has been generated by the image analyzing section.

According to the configuration, the conveyance of the present invention includes the operation controlling section that obtains the peripheral information generated by the image analyzing section. Here, the peripheral information may indicate an event such as a slope or an obstacle existing in front of the conveyance.

In this case, the operation controlling section can control a parameter such as the speed at which or the direction in which the conveyance moves, in accordance with the obtained peripheral information. Alternatively, the operation controlling section can control a device such as an alarming device to issue a warning to notify an operator, etc. of the conveyance of danger, in accordance with the obtained peripheral information. As such, the conveyance of the present invention can improve traffic safety by avoiding various dangers.

In the conveyance in accordance with an aspect of the present invention, it is possible that the conveyance is a vehicle; and the image analyzing section generates peripheral information indicative of at least one of (i) presence of a slope, (ii) an angle of a slope, (iii) presence of an obstacle, (iv) unevenness of a road, (v) presence of an oncoming vehicle and/or a vehicle running parallel to the vehicle, (vi) a width of a road, and (vii) a height of an elevated road.

According to the configuration, various risk factors which can occur while driving the vehicle are dealt with as the peripheral information. Therefore, the conveyance of the present invention can secure higher degree of safely for a user.

Note that examples of the obstacle encompass various tangible things such as a passer-by, an animal, a bicycle, a child running into the road, and a dropped object on the road.

The conveyance in accordance with an aspect of the present invention can further include an output section for notifying a person, who is on the conveyance, of the peripheral information.

According to the configuration, the output section outputs the peripheral information with respect to the person on the conveyance. This allows the person on the conveyance to quickly notice the peripheral information.

Note that the peripheral information generating apparatus (the method for generating peripheral information) can be realized by a computer. In such a case, the present invention encompasses (i) a peripheral information generating program which causes the computer to serve as the peripheral information generating apparatus (the method for generating peripheral information) by causing the computer to carry out the projection step, the image capturing step, and the image analyzing step and (ii) a computer-readable storage medium which stores the peripheral information generating program.

[Additional Remarks]

Lastly, blocks of the peripheral information generating apparatus 1, in particular, the projection section 10, the image capturing section 20, and the image analyzing section 30 can be configured by hardware logic or realized by software with the use of CPU as follows.

That is, the peripheral information generating apparatus 1 includes a CPU (central processing unit), a ROM (read only memory), a RAM (random access memory), and a storage device (storage medium) such as a memory. The CPU executes instructions of control programs for realizing the functions of the peripheral information generating apparatus 1. In the ROM, the programs are stored. Into the RAM the programs are loaded. In the storage device, the programs and various data are stored. The objective of the present invention can also be achieved, by (i) supplying a storage medium, in which program codes (executable programs, intermediate code programs, source programs) of programs, which are software for realizing the functions, for controlling the peripheral information generating apparatus 1, are stored so that a computer can read them, to the peripheral information generating apparatus 1, and then (ii) causing the computer (or CPU or MPU) to read and execute the program codes stored in the storage medium.

The storage medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM, or flash ROM.

Alternatively, the peripheral information generating apparatus 1 can be arranged to be connected to a communications network so that the program codes are delivered over the communications network. The communications network is not limited to a specific one, and therefore can be, for example, the Internet, an intranet, extranet, LAN, ISDN, VAN, CATV communications network, virtual private network, telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR (high data rate), mobile telephone network, satellite line, or terrestrial digital network. Note that, the present invention can be realized by a computer data signal (i) which is realized by electronic transmission of the program code and (ii) which is embedded in a carrier wave.

The present invention is not limited to the embodiments, but can be altered by a skilled person in the art within the scope of the claims. An embodiment derived from a proper combination of technical means appropriately altered within the scope of the claims is also encompassed in the technical scope of the present invention.

### INDUSTRIAL APPLICABILITY

The present invention relates to a peripheral information generating apparatus that can generate peripheral information, which indicates a peripheral situation of the peripheral information generating apparatus and of a projection target, by analyzing a projection pattern. In particular, the present invention is suitably applicable to a conveyance such as a vehicle.

### REFERENCE SIGNS LIST

1: Peripheral information generating apparatus
10: Projection section
11: Light source (projection section)
12: Lens (projection section)
13: Hologram (projection section)
20: Image capturing section
30: Image analyzing section
50: Vehicle
60: Operation controlling section
70: Output section

1. A peripheral information generating apparatus comprising:
a projection section for forming a projection pattern, which at least partially has a continuous profile, on a surface of a projection target by irradiating the projection target with light;
an image capturing section for capturing an image of the projection pattern formed on the surface; and
an image analyzing section for generating peripheral information, which indicates a peripheral situation of said peripheral information generating apparatus and of the projection target, by analyzing the projection pattern in the image captured by the image capturing section.

2. The peripheral information generating apparatus as set forth in claim 1, wherein:
in a case where at least one of (i) an event in the projection target and (ii) the projection pattern moves, the image analyzing section generates the peripheral information for each of all events that pass through a contour of the projection pattern.

3. The peripheral information generating apparatus as set forth in claim 1, wherein:
the projection pattern intersects, in at least one location, with an arbitrary straight line passing through a point which exists within the contour of the projection pattern.

4. The peripheral information generating apparatus as set forth in claim 1, wherein:
the projection pattern has at least one of a lattice shape and a closed continuous profile.

5. The peripheral information generating apparatus as set forth in claim 1, wherein:
the projection section emits the light so that the projection pattern is wholly projected on the surface at a time.

6. The peripheral information generating apparatus as set forth in claim 1, wherein:
the image analyzing section generates, as the peripheral information, information indicative of a shape of the projection target based on a distortion of the projection pattern in the image.

7. The peripheral information generating apparatus as set forth in claim 1, wherein:
the image analyzing section generates, as the peripheral information, information indicative of a distance between said peripheral information generating apparatus and the projection target based on a size of the projection pattern in the image.

8. The peripheral information generating apparatus as set forth in claim 7, wherein:
an entire shape of the projection pattern is recognized from a part of the projection pattern.

9. The peripheral information generating apparatus as set forth in claim 1, wherein:
the light has a wavelength different from that of sunlight.

10. The peripheral information generating apparatus as set forth in claim 1, wherein:
the light has a wavelength which falls within an infrared region or within an ultraviolet region.

11. The peripheral information generating apparatus as set forth in claim 1, wherein:
the light has a wavelength which falls within a visible region.

12. The peripheral information generating apparatus as set forth in claim 1, wherein:
the projection section projects the projection pattern with use of a laser beam.

13. A conveyance comprising a peripheral information generating apparatus recited in claim 1.

14. A conveyance as set forth in claim 13, further comprising:
an operation controlling section for controlling at least one of a speed at which said conveyance moves, a direction in which said conveyance moves, and issuing of a warning, in accordance with obtained peripheral information which has been generated by the image analyzing section.

15. The conveyance as set forth in claim 13, wherein:
said conveyance is a vehicle; and
the image analyzing section generates peripheral information indicative of at least one of (i) presence of a slope, (ii) an angle of a slope, (iii) presence of an obstacle, (iv) unevenness of a road, (v) presence of an oncoming vehicle and/or a vehicle running parallel to said vehicle, (vi) a width of a road, and (vii) a height of an elevated road.

16. A conveyance as set forth in claim 13, further comprising:
an output section for notifying a person, who is on said conveyance, of the peripheral information.

17. A method for generating peripheral information, said method comprising the steps of:
(a) forming a projection pattern, which at least partially has a continuous profile, on a surface of a projection target by irradiating the projection target with light;
(b) capturing an image of the projection pattern formed on the surface in the step (a); and
(c) generating peripheral information, which indicates a peripheral situation of the projection target, by analyzing the projection pattern in the image captured in the step (b).

18. A non-transitory computer-readable storage medium which stores a program for generating peripheral information, the program causing a computer to carry out the steps recited in claim 17.
